(19) United States
(12) Patent Application Publication
(10) Pub. No.: US 2024/0362711 A1
(43) Pub. Date: Oct. 31, 2024

(54) METHOD AND SYSTEM FOR FACILITATING INTEGRATED COMPUTATIONS

(71) Applicant: JPMorgan Chase Bank, N.A., New York, NY (US)

(72) Inventors: Chandra GORANTLA, Sugar Land, TX (US); Swapnil PORE, Mumbai (IN); Sumit KHANNA, East Windsor, NJ (US); Karthigeyan KUPPAN, Houston, TX (US); Aswani DAMMALAPATI, Katy, TX (US); Kevin FUNG, Warren, NJ (US); Dahai ZHENG, Sugar Land, TX (US)

(73) Assignee: JPMorgan Chase Bank, N.A., New York, NY (US)

(21) Appl. No.: 18/208,571

(22) Filed: Jun. 12, 2023

(30) Foreign Application Priority Data
Apr. 29, 2023 (IN) 202311030893

(51) Int. Cl. G06Q 40/04

(52) U.S. Cl. CPC G06Q 40/04

(57) ABSTRACT

A method for facilitating integrated computations in a microservice environment is disclosed. The method includes determining a list of profiles based on a generated global context, the list relating to an ordered representation of the profiles for calculating; loading data sets from various sources, each of the data sets including a context identifier; aggregating trade data from a trade capture listener to prepare for the calculating, the trade data including trade valuation data; retrieving position data for each of the profiles in the list, the position data including corresponding position valuation data; invoking computation devices for each of the profiles in the list based on a corresponding agreement type, the data sets, the trade data, and the position data; and notifying downstream applications based on the corresponding agreement type, the notification including an availability of a calculation result from the computation devices.

### CROSS-REFERENCE TO RELATED APPLICATIONS

This application claims the benefit of Indian Non-Provisional patent application No. 202311030893, filed Apr. 29, 2023, which is hereby incorporated by reference in its entirety.

### BACKGROUND

### 1. Field of the Disclosure

This technology generally relates to methods and systems for integrating various computations, and more particularly to methods and systems for facilitating integration of numerous calculations in a microservice environment to enhance efficiency, scalability, and performance.

### 2. Background Information

Many business entities rely on various calculations and computations that together enable the entities to provide services for users. Often, mechanisms for performing these various calculations and computations are siloed and isolated from one another. Historically, implementations of conventional integration techniques for these various calculations and computations have resulted in varying degrees of success with respect to efficiency, scalability, and performance.

One drawback of using the conventional integration techniques is that in many instances, many products, and variations of the products, rely on different siloed calculations that are computed in complete isolation. As a result, breaks and discrepancies regularly occur between each of the products. Additionally, due to a lack of coordination between each of the siloed calculation components, duplication of large quantities of data and code results in inefficient resource overhead for supporting the products.

Therefore, there is a need for a strategic application that utilizes a microservice architecture to facilitate the integration of numerous calculations to improve efficiency, scalability, and performance.

### SUMMARY

The present disclosure, through one or more of its various aspects, embodiments, and/or specific features or sub-components, provides, inter alia, various systems, servers, devices, methods, media, programs, and platforms for facilitating integration of numerous calculations in a microservice environment to enhance efficiency, scalability, and performance.

According to an aspect of the present disclosure, a method for facilitating integrated computations in a microservice environment is disclosed. The method is implemented by at least one processor. The method may include determining a list of at least one profile based on a generated global context, the list may relate to an ordered representation of the at least one profile for calculating; loading at least one data set from at least one source, each of the at least one data set may include a context identifier; aggregating trade data from a trade capture listener to prepare for the calculating, the trade data may include trade valuation data; retrieving position data for each of the at least one profile in the list, the position data may include corresponding position valuation data; invoking at least one computation device for each of the at least one profile in the list based on a corresponding agreement type, the at least one data set, the trade data, and the position data; and notifying at least one downstream application based on the corresponding agreement type, the notification may include an availability of a calculation result from the at least one computation device.

In accordance with an exemplary embodiment, the global context may be generated based on a close of business date and region information, the global context may include agreement-agnostic reference data and agreement-specific data.

In accordance with an exemplary embodiment, the at least one data set may correspond to reference data and global market data, the at least one data set may include at least one from among an exchange rate data set, a financial instrument data set, a required value data set, and a credit rating data set.

In accordance with an exemplary embodiment, the trade capture listener may correspond to a database server process that receives client connection requests and manages associated network traffic.

In accordance with an exemplary embodiment, the position data may include holding information at a predetermined time for each of the at least one profile that is retrieved from at least one subledger; and the corresponding position valuation data may include value information for each of the at least one profile.

In accordance with an exemplary embodiment, the aggregated trade data and the retrieved position data may be persisted in a data repository, the data repository may include an operational data store that is accessible by the at least one computation device in real-time.

In accordance with an exemplary embodiment, the corresponding agreement type may relate to a service level agreement that enables the at least one downstream application to process an agreement based on the availability of the calculation result.

In accordance with an exemplary embodiment, the method may further include receiving at least one call from the at least one downstream application in response to the notification, the at least one call may include a data requirement; generating a structured data set based on the data requirement, the structured data set may correspond to the calculation result; and transmitting the structured data set to the at least one downstream application in response to the at least one call.

In accordance with an exemplary embodiment, the data requirement may include a data format requirement that defines a structure for data in the structured data set, the structure may provide meaning to the data in the structured data set.

According to an aspect of the present disclosure, a computing device configured to implement an execution of a method for facilitating integrated computations in a microservice environment is disclosed. The computing device including a processor; a memory; and a communication interface coupled to each of the processor and the memory, wherein the processor may be configured to determine a list of at least one profile based on a generated global context, the list may relate to an ordered representation of the at least one profile for calculating; load at least one data set from at least one source, each of the at least one data set may include a context identifier; aggregate trade data from a trade capture listener to prepare for the calculating, the trade data may include trade valuation data; retrieve position data for each of the at least one profile in the list, the position data may include corresponding position valuation data; invoke at least one computation device for each of the at least one profile in the list based on a corresponding agreement type, the at least one data set, the trade data, and the position data; and notify at least one downstream application based on the corresponding agreement type, the notification may include an availability of a calculation result from the at least one computation device.

In accordance with an exemplary embodiment, the processor may be further configured to generate the global context based on a close of business date and region information, the global context may include agreement-agnostic reference data and agreement-specific data.

In accordance with an exemplary embodiment, the at least one data set may correspond to reference data and global market data, the at least one data set may include at least one from among an exchange rate data set, a financial instrument data set, a required value data set, and a credit rating data set.

In accordance with an exemplary embodiment, the trade capture listener may correspond to a database server process that receives client connection requests and manages associated network traffic.

In accordance with an exemplary embodiment, the position data may include holding information at a predetermined time for each of the at least one profile that is retrieved from at least one subledger; and the corresponding position valuation data may include value information for each of the at least one profile.

In accordance with an exemplary embodiment, the processor may be further configured to persist the aggregated trade data and the retrieved position data in a data repository, the data repository may include an operational data store that is accessible by the at least one computation device in real-time.

In accordance with an exemplary embodiment, the corresponding agreement type may relate to a service level agreement that enables the at least one downstream application to process an agreement based on the availability of the calculation result.

In accordance with an exemplary embodiment, wherein the processor may be further configured to receive at least one call from the at least one downstream application in response to the notification, the at least one call may including a data requirement; generate a structured data set based on the data requirement, the structured data set may correspond to the calculation result; and transmit the structured data set to the at least one downstream application in response to the at least one call.

In accordance with an exemplary embodiment, the data requirement may include a data format requirement that defines a structure for data in the structured data set, the structure may provide meaning to the data in the structured data set.

According to an aspect of the present disclosure, a non-transitory computer readable storage medium storing instructions for facilitating integrated computations in a microservice environment is disclosed. The storage medium including executable code which, when executed by a processor, may cause the processor to determine a list of at least one profile based on a generated global context, the list may relate to an ordered representation of the at least one profile for calculating; load at least one data set from at least one source, each of the at least one data set may include a context identifier; aggregate trade data from a trade capture listener to prepare for the calculating, the trade data may include trade valuation data; retrieve position data for each of the at least one profile in the list, the position data may include corresponding position valuation data; invoke at least one computation device for each of the at least one profile in the list based on a corresponding agreement type, the at least one data set, the trade data, and the position data; and notify at least one downstream application based on the corresponding agreement type, the notification may include an availability of a calculation result from the at least one computation device.

In accordance with an exemplary embodiment, when executed by the processor, the executable code may further cause the processor to generate the global context based on a close of business date and region information, the global context may include agreement-agnostic reference data and agreement-specific data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating integration of numerous calculations in a microservice environment to enhance efficiency, scalability, and performance.

FIG. 4 is a flowchart of an exemplary process for implementing a method for facilitating integration of numerous calculations in a microservice environment to enhance efficiency, scalability, and performance.

FIG. 5 is a high-level architecture of an exemplary process for implementing a method for facilitating integration of numerous calculations in a microservice environment to enhance efficiency, scalability, and performance.

FIG. 6 is a flow template of an exemplary calculation process for implementing a method for facilitating integration of numerous calculations in a microservice environment to enhance efficiency, scalability, and performance.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

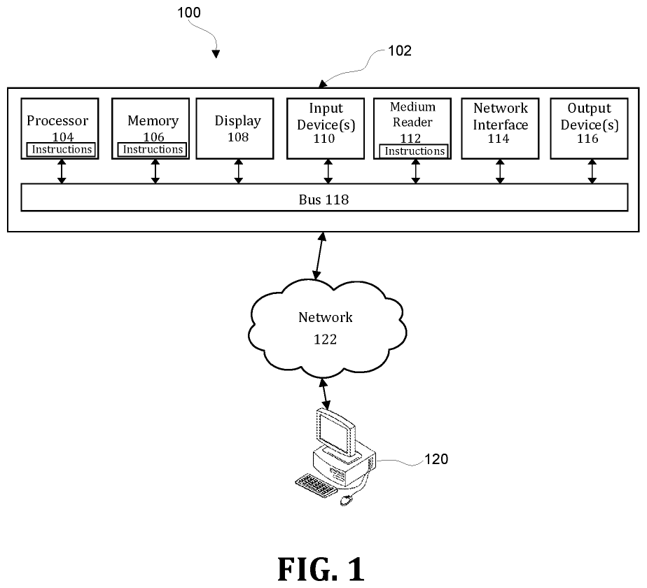

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating integration of numerous calculations in a microservice environment to enhance efficiency, scalability, and performance.

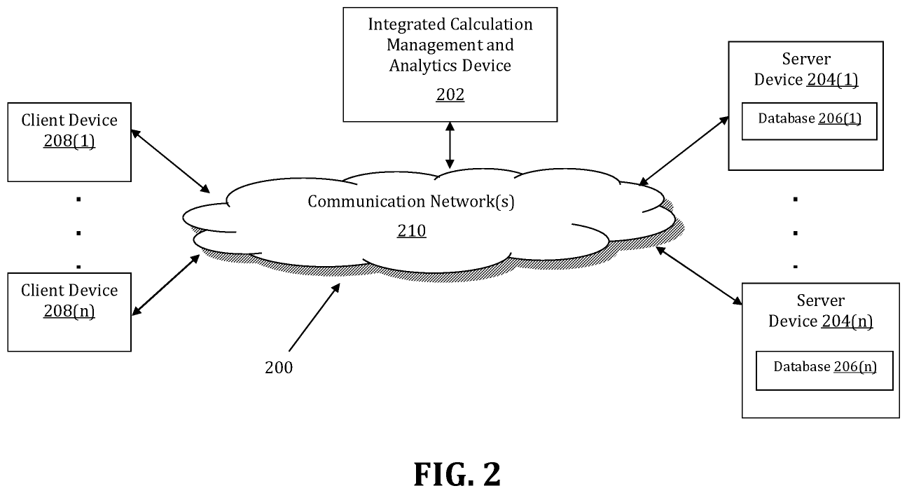

Referring to FIG. 2, a schematic of an exemplary network environment 200 for implementing a method for facilitating integration of numerous calculations in a microservice environment to enhance efficiency, scalability, and performance is illustrated. In an exemplary embodiment, the method is executable on any networked computer platform, such as, for example, a personal computer (PC).

The method for facilitating integration of numerous calculations in a microservice environment to enhance efficiency, scalability, and performance may be implemented by an Integrated Calculation Management and Analytics (ICMA) device 202. The ICMA device 202 may be the same or similar to the computer system 102 as described with respect to FIG. 1. The ICMA device 202 may store one or more applications that can include executable instructions that, when executed by the ICMA device 202, cause the ICMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ICMA device 202 itself, may be located in virtual server(s) running in a cloud-based computing environment rather than being tied to one or more specific physical network computing devices. Also, the application(s) may be running in one or more virtual machines (VMs) executing on the ICMA device 202. Additionally, in one or more embodiments of this technology, virtual machine(s) running on the ICMA device 202 may be managed or supervised by a hypervisor.

In the network environment 200 of FIG. 2, the ICMA device 202 is coupled to a plurality of server devices 204(1)-204 (n) that hosts a plurality of databases 206(1)-206 (n), and also to a plurality of client devices 208(1)-208(n) via communication network(s) 210. A communication interface of the ICMA device 202, such as the network interface 114 of the computer system 102 of FIG. 1, operatively couples and communicates between the ICMA device 202, the server devices 204(1)-204 (n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ICMA device 202, the server devices 204(1)-204 (n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ICMA devices that efficiently implement a method for facilitating integration of numerous calculations in a microservice environment to enhance efficiency, scalability, and performance.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ICMA device 202 may be a standalone device or integrated with one or more other devices or apparatuses, such as one or more of the server devices 204(1)-204 (n), for example. In one particular example, the ICMA device 202 may include or be hosted by one of the server devices 204(1)-204 (n), and other arrangements are also possible. Moreover, one or more of the devices of the ICMA device 202 may be in a same or a different communication network including one or more public, private, or cloud networks, for example.

The plurality of server devices 204(1)-204 (n) may be the same or similar to the computer system 102 or the computer device 120 as described with respect to FIG. 1, including any features or combination of features described with respect thereto. For example, any of the server devices 204(1)-204 (n) may include, among other features, one or more processors, a memory, and a communication interface, which are coupled together by a bus or other communication link, although other numbers and/or types of network devices may be used. The server devices 204(1)-204 (n) in this example may process requests received from the ICMA device 202 via the communication network(s) 210 according to the HTTP-based and/or JavaScript Object Notation (JSON) protocol, for example, although other protocols may also be used.

The server devices 204(1)-204 (n) may be hardware or software or may represent a system with multiple servers in a pool, which may include internal or external networks. The server devices 204(1)-204 (n) hosts the databases 206(1)-206 (n) that are configured to store data that relates to profile lists, global contexts, ordered representations, data sets, context identifiers, trade data, trade valuation data, position data, position valuation data, agreement types, and calculation results.

Although the server devices 204(1)-204 (n) are illustrated as single devices, one or more actions of each of the server devices 204(1)-204 (n) may be distributed across one or more distinct network computing devices that together comprise one or more of the server devices 204(1)-204 (n). Moreover, the server devices 204(1)-204 (n) are not limited to a particular configuration. Thus, the server devices 204(1)-204 (n) may contain a plurality of network computing devices that operate using a controller/agent approach, whereby one of the network computing devices of the server devices 204(1)-204 (n) operates to manage and/or otherwise coordinate operations of the other network computing devices.

The server devices 204(1)-204 (n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ICMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ICMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ICMA device 202, the server devices 204(1)-204 (n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ICMA device 202, the server devices 204(1)-204 (n), or the client devices 208(1)-208 (n), for example, may be configured to operate as virtual instances on the same physical machine. In other words, one or more of the ICMA device 202, the server devices 204(1)-204 (n), or the client devices 208(1)-208(n) may operate on the same physical device rather than as separate devices communicating through communication network(s) 210. Additionally, there may be more or fewer ICMA devices 202, server devices 204(1)-204 (n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

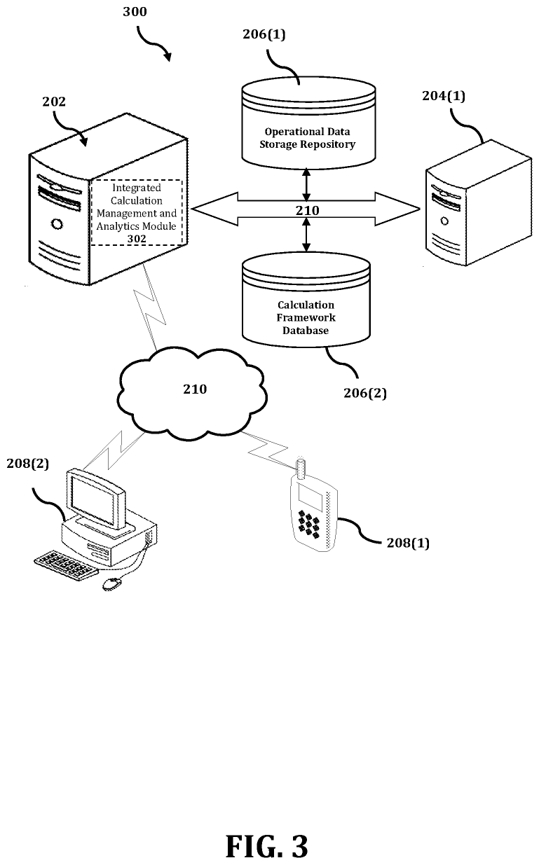

The ICMA device 202 is described and shown in FIG. 3 as including an integrated calculation management and analytics module 302, although it may include other rules, policies, modules, databases, or applications, for example. As will be described below, the integrated calculation management and analytics module 302 is configured to implement a method for facilitating integration of numerous calculations in a microservice environment to enhance efficiency, scalability, and performance.

An exemplary process 300 for implementing a mechanism for facilitating integration of numerous calculations in a microservice environment to enhance efficiency, scalability, and performance by utilizing the network environment of FIG. 2 is shown as being executed in FIG. 3. Specifically, a first client device 208(1) and a second client device 208(2) are illustrated as being in communication with ICMA device 202. In this regard, the first client device 208(1) and the second client device 208(2) may be “clients” of the ICMA device 202 and are described herein as such. Nevertheless, it is to be known and understood that the first client device 208(1) and/or the second client device 208(2) need not necessarily be “clients” of the ICMA device 202, or any entity described in association therewith herein. Any additional or alternative relationship may exist between either or both of the first client device 208(1) and the second client device 208(2) and the ICMA device 202, or no relationship may exist.

Further, ICMA device 202 is illustrated as being able to access an operational data storage repository 206 (1) and a calculation framework database 206(2). The integrated calculation management and analytics module 302 may be configured to access these databases for implementing a method for facilitating integration of numerous calculations in a microservice environment to enhance efficiency, scalability, and performance.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ICMA device 202 via broadband or cellular communication. Of course, these embodiments are merely exemplary and are not limiting or exhaustive.

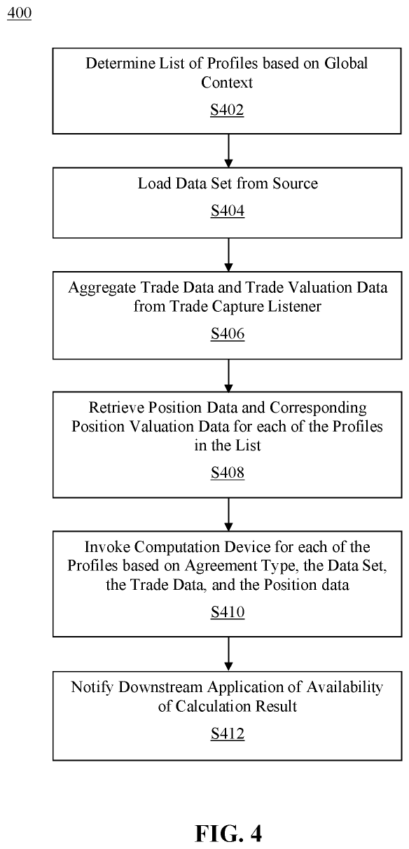

Upon being started, the integrated calculation management and analytics module 302 executes a process for facilitating integration of numerous calculations in a microservice environment to enhance efficiency, scalability, and performance. An exemplary process for facilitating integration of numerous calculations in a microservice environment to enhance efficiency, scalability, and performance is generally indicated at flowchart 400 in FIG. 4.

In the process 400 of FIG. 4, at step S402, a list of profiles may be determined based on a generated global context. The list may relate to an ordered representation of the profiles for calculating. In an exemplary embodiment, the profiles may correspond to a collection of settings and information that relates to a user such as, for example, an owner of a financial portfolio. The list may include profiles for which calculations need to be processed. In another exemplary embodiment, the profiles may correspond to a collection of settings and information that relates to a range of financial instruments that are held by a person and/or organization such as, for example, the financial portfolio itself.

In another exemplary embodiment, the list may correspond to a finalized listing of the profiles. The finalized listing of the profiles may be generated based on the global context to include profiles to be calculated. In another exemplary embodiment, the list of profiles may be finalized from a plurality of profiles. The list of profiles may be finalized from amongst the plurality of profiles based on the global context.

In another exemplary embodiment, the global context may be created based on a close of business date and region. The global context may represent data dependency and may be generated based on the close of business date and region information. In another exemplary embodiment, the global context may include agreement-agnostic reference data and agreement-specific data. The agreement-agnostic reference data may include instrument data, regional foreign exchange rate data, pricing data, and rating data. The agreement-specific data may include profile data, contract valuations data, collateral holdings data, trade data, trade valuations data, and overrides data.

In another exemplary embodiment, actions described above such as, for example, finalizing the list of profiles and generating the global context may each be performed by using software applications. Each of the actions may be performed together, separately, and in any combinations thereof by using the software applications. Further, each of the actions may be completed synchronously, asynchronously, and in any combinations thereof via the software applications. Consistent with present disclosures, the software applications may operate within a networked computing environment. The software applications may communicate in the networked computing environment by using a network interface such as, for example, an application programming interface.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, data sets may be loaded from various sources. Each of the data sets may include a context identifier. In an exemplary embodiment, the data sets may correspond to reference data sets and global market data sets. The data sets may include at least one from among an exchange rate data set, a financial instrument data set, a required value data set, and a credit rating data set. In another exemplary embodiment the data sets may include data that are required for predetermined calculations and computations. The data sets may be identified for the predetermined calculations and computations based on the context identifier and an available global context.

In another exemplary embodiment, the various sources may include first-party data sources such as, for example, internal data storage devices. The first-party data sources may relate to and/or may directly be involved with actions relating to calculations as presently disclosed herein. In another exemplary embodiment, the various sources may include third-party data sources such as, for example, external market data. The third-party data sources may correspond to a trading platform such as, for example, a stock exchange that provides pricing information and other related data for a financial instrument.

Consistent with present disclosures, actions described above such as, for example, loading the data sets may each be performed by using software applications. Each of the actions may be performed together, separately, and in any combinations thereof by using the software applications. Further, each of the actions may be completed synchronously, asynchronously, and in any combinations thereof via the software applications. In another exemplary embodiment, the software applications may operate within a networked computing environment. The software applications may communicate in the networked computing environment by using a network interface such as, for example, an application programming interface.

At step S406, trade data may be aggregated from a trade capture listener to prepare for the calculating. The trade data may include trade valuation data. In an exemplary embodiment, the trade data may include information that relates to a transaction. The transaction may correspond to a profile in the finalized list of profiles. For example, the trade data may include transaction information for a certain financial instrument that is associated with a profile in the finalized list of profiles.

In another exemplary embodiment, the trade capture listener may correspond to a database server process that receives client connection requests and manages associated network traffic. The trade capture listener may relate to a separate process that runs on the database server computer. In another exemplary embodiment, the trade capture listener may correspond to an event listener. The event listener may relate to a function in a computer program the waits for an event to occur. The event listener may react to an input and/or signal by calling the event's handler

Consistent with present disclosures, actions described above such as, for example, aggregating trade data may each be performed by using software applications. Each of the actions may be performed together, separately, and in any combinations thereof by using the software applications. Further, each of the actions may be completed synchronously, asynchronously, and in any combinations thereof via the software applications. In another exemplary embodiment, the software applications may operate within a networked computing environment. The software applications may communicate in the networked computing environment by using a network interface such as, for example, an application programming interface.

At step S408, position data for each of the profiles in the list may be retrieved. The position data may include corresponding position valuation data. In an exemplary embodiment, the position data may include holding information at a predetermined time for each of the profiles. The holding information may be retrieved from a subledger that operates within the networked computing environment consistent with present disclosures. In another exemplary embodiment, the corresponding position valuation data may include value information for each of the profiles. The value information may correspond to market data such as, for example, a market price that is associated with the profiles and/or the financial instruments within the profiles.

Consistent with present disclosures, actions described above such as, for example, retrieving position data may each be performed by using software applications. Each of the actions may be performed together, separately, and in any combinations thereof by using the software applications. Further, each of the actions may be completed synchronously, asynchronously, and in any combinations thereof via the software applications. In another exemplary embodiment, the software applications may operate within a networked computing environment. The software applications may communicate in the networked computing environment by using a network interface such as, for example, an application programming interface.

At step S410, computation devices such as, for example, calculators may be invoked for each of the profiles in the list. The computation devices may be invoked based on a corresponding agreement type, the data sets, the trade data, and the position data. Consistent with present disclosures, the computation devices may include a total margin calculator, a variation margin calculator, an initial margin calculator, a collateral holdings calculator, and an excess deficit calculator. Each of the calculators may be activated in any combination based on user configurations for various asset classes. For example, a user may configure a specific set of calculators to be active for calculations relating to a specific asset class such as over the counter derivative products.

In another exemplary embodiment, the aggregated trade data and the retrieved position data may be persisted in a data repository. The data repository may include an operational data store that is accessible by the computation devices in real-time. For example, to facilitate the calculations for a particular profile, the computation devices may directly access the operational data store in real-time to retrieve the necessary trade data and the necessary position data that correspond to the particular profile.

Consistent with present disclosures, actions described above such as, for example, actions taken by the computation devices may each be performed by using software applications. Each of the actions may be performed together, separately, and in any combinations thereof by using the software applications. Further, each of the actions may be completed synchronously, asynchronously, and in any combinations thereof via the software applications. In another exemplary embodiment, the software applications may operate within a networked computing environment. The software applications may communicate in the networked computing environment by using a network interface such as, for example, an application programming interface.

At step S412, downstream applications may be notified based on the corresponding agreement type. The notification may include an availability of a calculation result from the computation devices. In an exemplary embodiment, the corresponding agreement type may relate to a service level agreement that enables the downstream applications to process an agreement based on the availability of the calculation result. The downstream applications may process the agreements as and when the calculation results are available.

In another exemplary embodiment, calls may be received from the downstream applications in response to the notification. The calls may include data requirements that are unique to each of the downstream applications. Then, a structured data set may be generated based on each of the data requirements. The structured data set may correspond to and include the calculation results. In another exemplary embodiment, the data requirements may include a data format requirement that defines a structure for data in the structured data set. The structure may provide meaning to the data in the structured data set. Finally, the generated structured data set may be transmitted to the downstream applications in response to the calls. That is, each of the downstream applications may receive the structured data set in a format that is specified in the corresponding downstream calls.

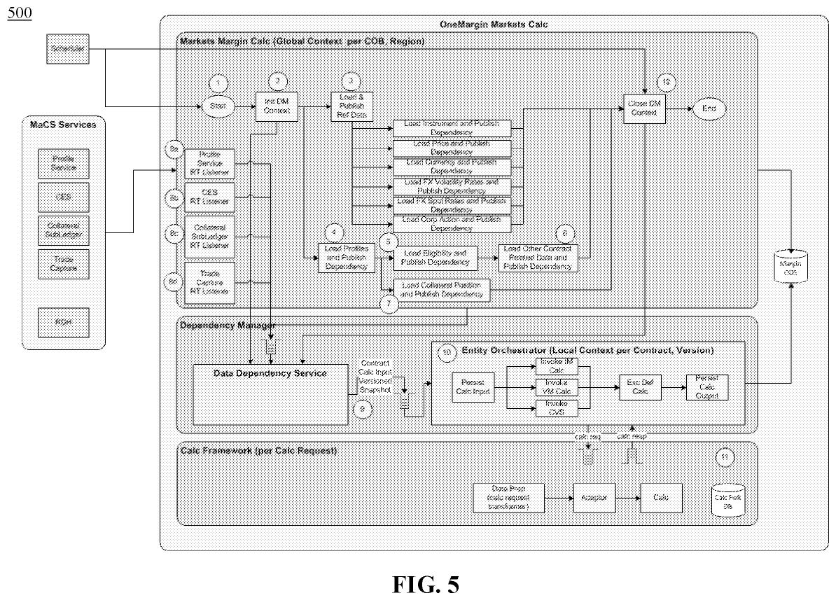

FIG. 5 is a high-level architecture 500 of an exemplary process for implementing a method for facilitating integration of numerous calculations in a microservice environment to enhance efficiency, scalability, and performance. In FIG. 5, a strategic computational device is disclosed. The strategic computational device may relate to a suite of calculation methodologies that are usable to identify various calculation results and corresponding actions such as, for example, excess deficits and call actions.

In an exemplary embodiment, the calculation methodologies may include a total margin methodology, a variation margin methodology, an initial margin methodology, a collateral holdings methodology, and an excess deficit methodology. The initial margin methodology may include multiple variations of margin methodologies that are based on agreement setup such as, for example, a regulated initial margin (IM), a standard initial margin model (SIMM), a SIMM plus, and a SIMM plus cross margin.

Consistent with present disclosures, the strategic computational device may be governed by guiding principles such as, for example, that all calculators may be stateless; that calculators may scale horizontally; that calculators may be rerun on failure without impacting other agreements; that standardized implementation across all calculators may help with code reusability; that calculators may be based on a microservices architecture; and that internal cloud environments may be leveraged to be ready for volume growth.

Additionally, consistent with present disclosures, the strategic computation device may satisfy objectives such as, for example, be event driven; have optimized calculators; have improved agreement good order (AGO)/statement good order (SGO) checks; have reduced risk from changes; and have improved service level agreement (SLA). To satisfy the event driven objective, the agreement, i.e., the margin node, level processing may be based on dependencies. To satisfy the optimized calculator objective, the calculation methodologies may be enhanced to support new IM calculations. To satisfy the improved AGO/SGO checks objective, dynamic threshold validation may be implemented by using standard deviation. To satisfy the reduced risk from changes objective, deployments may be independent and/or controlled without impacting other components. To satisfy the improved SLA objective, downstream applications may process agreements as and when calculation results such as, for example, margin results are available.

As illustrated in FIG. 5, the strategic computational device may be initiated at step 1 by a scheduler. Consistent with present disclosures, each of the provided steps may correspond to a microservice application that is a part of a choreography of microservices that corresponds to the strategic computational device. At step 2, a context such as, for example, a global context may be initiated. At step 3, reference data may be loaded and published. At step 4, profiles may be loaded, and dependencies may be published. At step 5, eligibilities may be loaded, and dependencies may be published. At step 6, other contract related data may be loaded, and dependencies may be published.

At step 7, collateral positions may be loaded, and dependencies may be published. At step 8, various listeners may aggregate data from corresponding services. For example, a profile service listener may aggregate profile data from a profile service. At step 9, contract calculation inputs may be versioned, and a corresponding snapshot may be generated. The data dependencies may be versioned, and versioned agreement dependency ready events may be published with the snapshot.

At step 10, an entity orchestrator may be usable to orchestrate various calculators. Actions may be initiated in the orchestration process per agreement dependency ready event. The actions may include a first action to create an agreement local context, a second action to persist calculation input, a third action to invoke IM and/or variation margin (VM) calculations per profile, and a fourth action to invoke excess/deficit calculations. At step 11, the calculation results may be persisted in an operational data store as well as in a calculation framework database. Then, at step 12, the context may be closed and the strategic computational device may end.

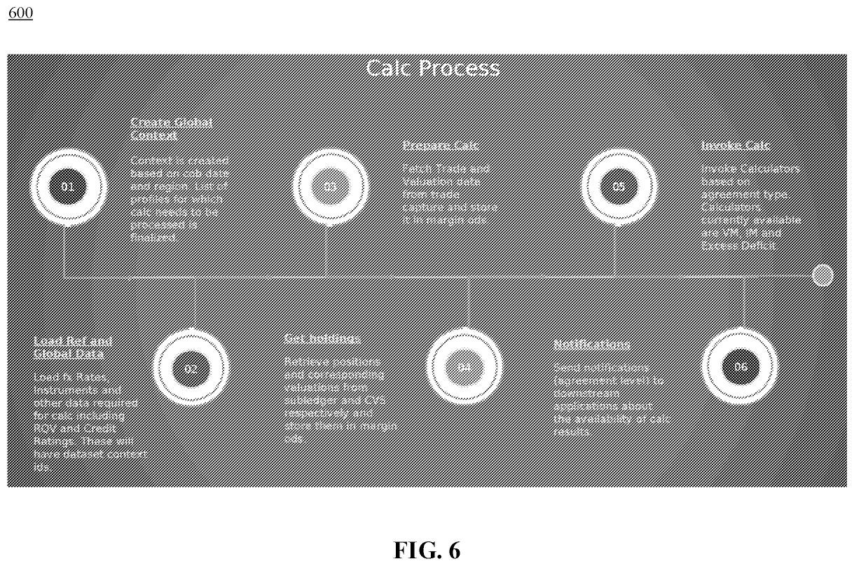

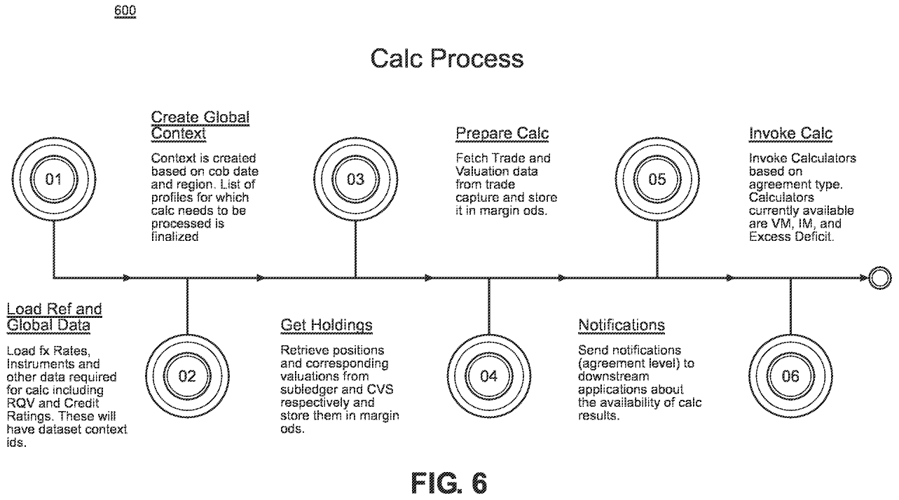

FIG. 6 is a flow template 600 of an exemplary calculation process for implementing a method for facilitating integration of numerous calculations in a microservice environment to enhance efficiency, scalability, and performance. In FIG. 6, a calculation process flow template may be provided for all types of calculators and asset classes.

As illustrated in FIG. 6, global context may be created at step 1. The global context may be created based on a close of business date and region information. A list of profiles for which calculation needs to be processed may also be finalized at this step. At step 2, reference and global data may be loaded. In this step, foreign exchange rate data, instrument data, credit rating data, and other data required for the calculation may be loaded. Each of the reference data and the global data may have data set context identifiers. At step 3, the calculation may be prepared. In this step, trade and valuation data may be fetched from trade capture devices and stored in an operational data store.

At step 4, holding data for each of the profiles may be aggregated. In this step, positions and corresponding valuations may be retrieved from subledgers and various other data management devices. The holding data may also be stored in the operational data store. At step 5, computation devices such as, for example, calculators may be invoked. The calculators may be invoked based on agreement type. The calculators may include variation margin calculators, initial margin calculators, and excess deficit calculators. At step 5, notifications may be generated. The notifications may be sent based on agreement level to downstream applications. The notifications may include information that relates to the availability of calculation results.

Accordingly, with this technology, an optimized process for facilitating integration of numerous calculations in a microservice environment to enhance efficiency, scalability, and performance is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating integrated computations in a microservice environment, the method being implemented by at least one processor, the method comprising:
determining, by the at least one processor, a list of at least one profile based on a generated global context, the list relating to an ordered representation of the at least one profile for calculating;
loading, by the at least one processor, at least one data set from at least one source, each of the at least one data set including a context identifier;
aggregating, by the at least one processor, trade data from a trade capture listener to prepare for the calculating, the trade data including trade valuation data;
retrieving, by the at least one processor, position data for each of the at least one profile in the list, the position data including corresponding position valuation data;
invoking, by the at least one processor, at least one computation device for each of the at least one profile in the list based on a corresponding agreement type, the at least one data set, the trade data, and the position data; and
notifying, by the at least one processor, at least one downstream application based on the corresponding agreement type, the notification including an availability of a calculation result from the at least one computation device.

2. The method of claim 1, wherein the global context is generated based on a close of business date and region information, the global context including agreement-agnostic reference data and agreement-specific data.

3. The method of claim 1, wherein the at least one data set corresponds to reference data and global market data, the at least one data set including at least one from among an exchange rate data set, a financial instrument data set, a required value data set, and a credit rating data set.

4. The method of claim 1, wherein the trade capture listener corresponds to a database server process that receives client connection requests and manages associated network traffic.

5. The method of claim 1, wherein the position data includes holding information at a predetermined time for each of the at least one profile that is retrieved from at least one subledger; and wherein the corresponding position valuation data includes value information for each of the at least one profile.

6. The method of claim 1, wherein the aggregated trade data and the retrieved position data is persisted in a data repository, the data repository including an operational data store that is accessible by the at least one computation device in real-time.

7. The method of claim 1, wherein the corresponding agreement type relates to a service level agreement that enables the at least one downstream application to process an agreement based on the availability of the calculation result.

8. The method of claim 1, further comprising:
receiving, by the at least one processor, at least one call from the at least one downstream application in response to the notification, the at least one call including a data requirement;
generating, by the at least one processor, a structured data set based on the data requirement, the structured data set corresponding to the calculation result; and
transmitting, by the at least one processor, the structured data set to the at least one downstream application in response to the at least one call.

9. The method of claim 8, wherein the data requirement includes a data format requirement that defines a structure for data in the structured data set, the structure providing meaning to the data in the structured data set.

10. A computing device configured to implement an execution of a method for facilitating integrated computations in a microservice environment, the computing device comprising:
a processor;
a memory; and
a communication interface coupled to each of the processor and the memory, wherein the processor is configured to:
determine a list of at least one profile based on a generated global context, the list relating to an ordered representation of the at least one profile for calculating;
load at least one data set from at least one source, each of the at least one data set including a context identifier;
aggregate trade data from a trade capture listener to prepare for the calculating, the trade data including trade valuation data;
retrieve position data for each of the at least one profile in the list, the position data including corresponding position valuation data;
invoke at least one computation device for each of the at least one profile in the list based on a corresponding agreement type, the at least one data set, the trade data, and the position data; and
notify at least one downstream application based on the corresponding agreement type, the notification including an availability of a calculation result from the at least one computation device.

11. The computing device of claim 10, wherein the processor is further configured to generate the global context based on a close of business date and region information, the global context including agreement-agnostic reference data and agreement-specific data.

12. The computing device of claim 10, wherein the at least one data set corresponds to reference data and global market data, the at least one data set including at least one from among an exchange rate data set, a financial instrument data set, a required value data set, and a credit rating data set.

13. The computing device of claim 10, wherein the trade capture listener corresponds to a database server process that receives client connection requests and manages associated network traffic.

14. The computing device of claim 10, wherein the position data includes holding information at a predetermined time for each of the at least one profile that is retrieved from at least one subledger; and wherein the corresponding position valuation data includes value information for each of the at least one profile.

15. The computing device of claim 10, wherein the processor is further configured to persist the aggregated trade data and the retrieved position data in a data repository, the data repository including an operational data store that is accessible by the at least one computation device in real-time.

16. The computing device of claim 10, wherein the corresponding agreement type relates to a service level agreement that enables the at least one downstream application to process an agreement based on the availability of the calculation result.

17. The computing device of claim 10, wherein the processor is further configured to:
receive at least one call from the at least one downstream application in response to the notification, the at least one call including a data requirement;
generate a structured data set based on the data requirement, the structured data set corresponding to the calculation result; and
transmit the structured data set to the at least one downstream application in response to the at least one call.

18. The computing device of claim 17, wherein the data requirement includes a data format requirement that defines a structure for data in the structured data set, the structure providing meaning to the data in the structured data set.

19. A non-transitory computer readable storage medium storing instructions for facilitating integrated computations in a microservice environment, the storage medium comprising executable code which, when executed by a processor, causes the processor to:
determine a list of at least one profile based on a generated global context, the list relating to an ordered representation of the at least one profile for calculating;
load at least one data set from at least one source, each of the at least one data set including a context identifier;
aggregate trade data from a trade capture listener to prepare for the calculating, the trade data including trade valuation data;
retrieve position data for each of the at least one profile in the list, the position data including corresponding position valuation data;
invoke at least one computation device for each of the at least one profile in the list based on a corresponding agreement type, the at least one data set, the trade data, and the position data; and
notify at least one downstream application based on the corresponding agreement type, the notification including an availability of a calculation result from the at least one computation device.

20. The storage medium of claim 19, wherein, when executed by the processor, the executable code further causes the processor to generate the global context based on a close of business date and region information, the global context including agreement-agnostic reference data and agreement-specific data.
